(19) United States
(12) Patent Application Publication
(10) Pub. No.: US 2023/0097392 A1
(43) Pub. Date: Mar. 30, 2023

(54) EVALUATION OF A VEHICLE SERVICE FOR A VEHICLE BASED ON INFORMATION ASSOCIATED WITH A USER OF THE VEHICLE

(71) Applicant: Capital One Services, LLC, McLean, VA (US)

(72) Inventors: Qiaochu TANG, Frisco, TX (US); Avid GHAMSARI, Carrollton, TX (US); Geoffrey DAGLEY, McKinney, TX (US)

(21) Appl. No.: 17/449,362

(22) Filed: Sep. 29, 2021

(51) Int. Cl. G06Q 30/00; G06Q 10/00

(52) U.S. Cl. CPC G06Q 30/016; G06Q 30/012; G06Q 10/20

(57) ABSTRACT

In some implementations, a system may receive exchange information associated with a vehicle and a user. The system may identify, based on the exchange information, a type of the vehicle. The system may determine a characteristic of the user based on a user profile associated with vehicle usage by the user. The system may determine, using a service evaluation model and based on the type of the vehicle and the characteristic of the user, an evaluation score associated with the vehicle service. The system may generate, based on the evaluation score satisfying a threshold, a recommendation that the exchange include a service package associated with the vehicle. The system may provide, to the user, the recommendation, to permit the user to opt into receiving the vehicle service based on including the service package in the exchange.

### BACKGROUND

A customer may engage in a transaction with an entity for a service and/or a good. The entity may be an individual and/or organization that provides the service and/or the good. In some cases, the customer may register and/or have an account with the entity (e.g., a financial account, a member account, and/or the like) that enables the customer and/or entity to access information associated with the transaction, the service, and/or the good. The account may be used to maintain and/or track information associated with the customer using records and/or a record log.

### SUMMARY

Some implementations described herein relate to a system for evaluating a vehicle service for a vehicle and a user. The system may include one or more memories and one or more processors communicatively coupled to the one or more memories. The system may be configured to receive exchange information associated with the vehicle and the user. The system may be configured to identify, based on the exchange information, a type of the vehicle. The system may be configured to determine a characteristic of the user based on a user profile associated with vehicle usage by the user. The system may be configured to determine, using a service evaluation model and based on the type of the vehicle and the characteristic of the user, an evaluation score associated with the vehicle service. The system may be configured to generate, based on the evaluation score satisfying a threshold, a recommendation that the exchange include a service package associated with the vehicle. The system may be configured to provide, to the user, the recommendation to permit the user to opt into receiving the vehicle service based on including the service package in the exchange.

Some implementations described herein relate to a non-transitory computer-readable medium that stores a set of instructions for a system. The set of instructions, when executed by one or more processors of the system, may cause the system to receive exchange information associated with a vehicle and a user. The set of instructions, when executed by one or more processors of the system, may cause the system to obtain, based on receiving the exchange information, user information associated with the user. The set of instructions, when executed by one or more processors of the system, may cause the system to analyze, in an account data structure, vehicle service information associated with user accounts that are related to a characteristic of the user. The set of instructions, when executed by one or more processors of the system, may cause the system to determine, based on the vehicle service information and a subset of the user accounts that include user profiles that identify the characteristic, an evaluation score that is associated with the user receiving the vehicle service. The set of instructions, when executed by one or more processors of the system, may cause the system to perform, based on the evaluation score satisfying a threshold, an action associated with a service package involving the vehicle service and the user.

Some implementations described herein relate to a method for evaluating a vehicle service for a vehicle and a user. The method may include receiving, by a device, exchange information associated with the vehicle and the user, where the exchange information indicates that the user is engaging in an exchange that involves the vehicle. The method may include identifying, by the device and based on a type of the vehicle, and within an account data structure, user accounts that are associated with the type of the vehicle. The method may include identifying, by the device and from a first subset of the user accounts, first records that are associated with vehicle maintenance, where first user accounts of the first subset are associated with first users that opted into receiving the vehicle service. The method may include identifying, by the device and from a second subset of the user accounts, second records that are associated with vehicle maintenance, where second user accounts of the second subset are associated with second users that opted out of receiving the vehicle service. The method may include determining, by the device and based on a comparison of the first records and the second records, an evaluation score associated with the vehicle service and the type of the vehicle. The method may include performing, by the device and based on the evaluation score, an action associated with the vehicle service and the user.

### BRIEF DESCRIPTION OF THE DRAWINGS

FIGS. 1A-1C are diagrams of an example implementation relating to a system for evaluating a vehicle service for a vehicle based on information associated with a user of the vehicle.

FIGS. 2A-1B are diagrams of an example implementation associated with evaluating a vehicle service for a vehicle based on information associated with a user of the vehicle.

FIG. 3 is a diagram of an example environment in which systems and/or methods described herein may be implemented.

FIG. 4 is a diagram of example components of one or more devices of FIG. 3.

FIG. 5 is a flowchart of an example process associated with evaluating a vehicle service for a vehicle based on information associated with a user of the vehicle.

### DETAILED DESCRIPTION

The following detailed description of example implementations refers to the accompanying drawings. The same reference numbers in different drawings may identify the same or similar elements.

In some instances, a consumer, when engaging in an exchange (e.g., a transaction or purchase) for a product, may consider additional products and/or services that may be associated with the product. For example, when purchasing a vehicle, a consumer may consider whether to purchase certain vehicle services in association with the exchange, such as an extended warranty for the vehicle, one or more types of insurance for the vehicle (e.g., gap insurance, liability insurance, and/or replacement insurance), whether to purchase certain vehicle protection plans (e.g., to prevent rust, to maintain a coating of paint, to maintain quality of an interior of the vehicle, or the like), whether to prepurchase maintenance packages (e.g., packages for oil change services, detailing services, or other types of maintenance, and so on). Additionally, or alternatively, the consumer may consider whether to purchase certain accessories for the vehicle (e.g., additional features or parts that are sold separately, such as roof storage racks, trailer hitches, or the like). Typically, the consumer is tasked with sifting through the various vehicle services or products during the purchase process (e.g., while at the dealership).

In many instances, such vehicle services and/or products may not provide any benefit to the consumer and/or the vehicle over the time period that the consumer owns the vehicle. Typically, the information that is available to the consumer only includes information associated with the vehicle service or product (e.g., a description of what the vehicle service involves) and/or a sales representative may provide additional information (whether accurate or not) to sell the products to the consumer (in order to benefit the sales representative rather than the consumer). Accordingly, based on that information, the consumer may not be able to reasonably predict whether a vehicle service or product is likely to provide a benefit to the consumer (e.g., save the consumer in monetary costs, save the consumer in additional maintenance on the vehicle, or the like).

Some implementations described herein provide a vehicle services system that enables a consumer (referred to herein as a “user”) to relatively quickly and seamlessly receive a recommendation for a vehicle service (and/or product) that is objectively determined to benefit the consumer according to a characteristic of the consumer (or a profile of the consumer) and/or according to a type of the vehicle. For example, the vehicle services system may include and/or utilize a service evaluation model that is trained based on historical data with previous vehicle exchanges. More specifically, the service evaluation model may include a machine learning model that is configured to extract features associated with previous exchanges involving vehicles, whether the previous exchanges involved users opting into a vehicle service in association with the vehicles, and/or user specific information associated with the users. Based on the features, the service evaluation model may determine whether a user engaging in an exchange for a vehicle would benefit from opting into a vehicle service. The service evaluation model may similarly evaluate multiple vehicle services and organize and/or rank the vehicle services based on the vehicle services that are most relevant to the user (e.g., according to those that are most beneficial to the user).

As described herein, the vehicle services system may obtain and/or collect the historical data in association with user accounts that are managed by the vehicle services system (and/or a user account system that is associated with an entity that owns or manages the vehicle services system). For example, the vehicle services system may be associated with an application that enables users to manage the user accounts and/or track or maintain vehicle information associated with the vehicles. The user accounts may be configured to track and/or maintain records associated with exchanges (or transactions) involving the users. For example, the user accounts may be associated with record logs that maintain records associated with exchanges involving the users (e.g., exchanges involving financial accounts of the users). The user accounts may maintain vehicle information associated with vehicles of the users.

In this way, via the user accounts, the vehicle services system may have access to real world, live, and/or up-to-date information associated with users that fit a certain user profile and/or that are associated with a certain type of vehicle. Accordingly, the vehicle services system and/or the service evaluation model, as described herein, can accurately evaluate, using the historical data (and/or the user accounts), a vehicle service for a user and a vehicle (e.g., a relevance of the vehicle service, a usefulness of the vehicle service, and/or whether the vehicle service is likely to benefit the user) and/or provide a recommendation associated with the vehicle service. Therefore, as described herein, based on the recommendation, a user may quickly and efficiently identify and/or opt into vehicle services that are likely to benefit the user, thereby conserving computing resources that would otherwise be wasted reviewing and/or analyzing multiple individual vehicle services (e.g., that would not be sorted or ranked by the vehicle services system, as described herein). Furthermore, the vehicle services system may identify and/or indicate certain vehicle services and/or products that, if provided to the user and/or applied to the vehicle, can reduce a likelihood of damage to the vehicle, thereby conserving hardware resources associated with the vehicle.

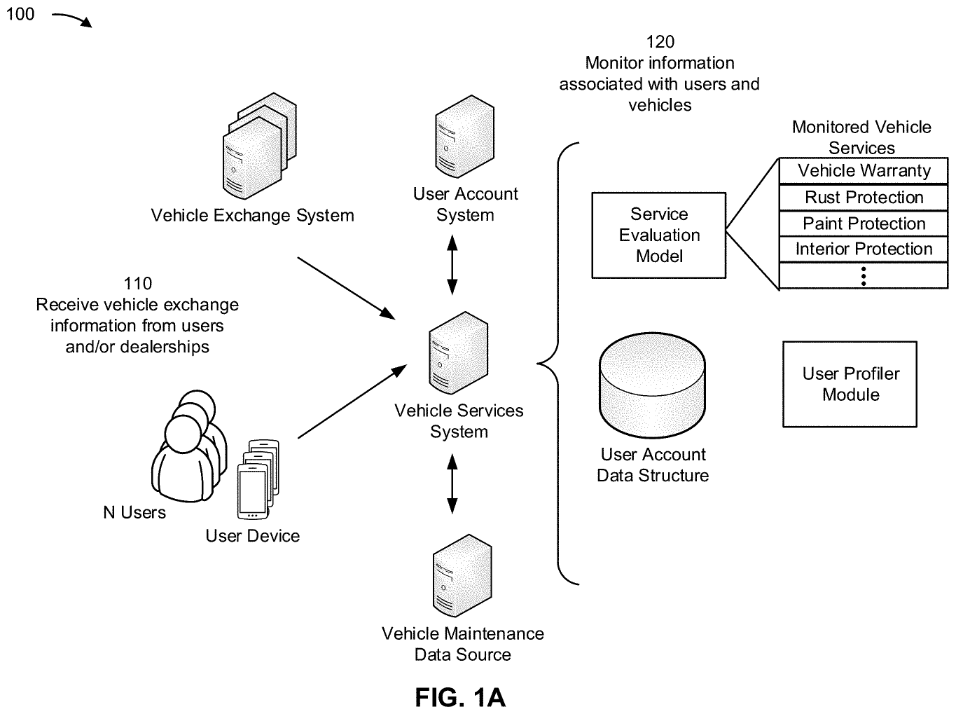

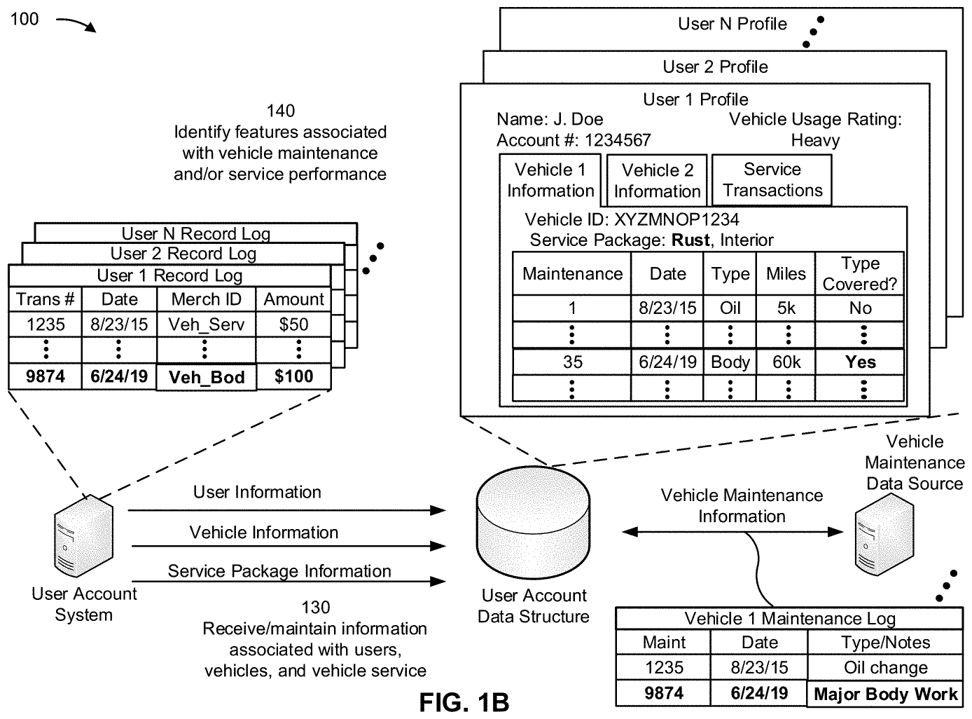

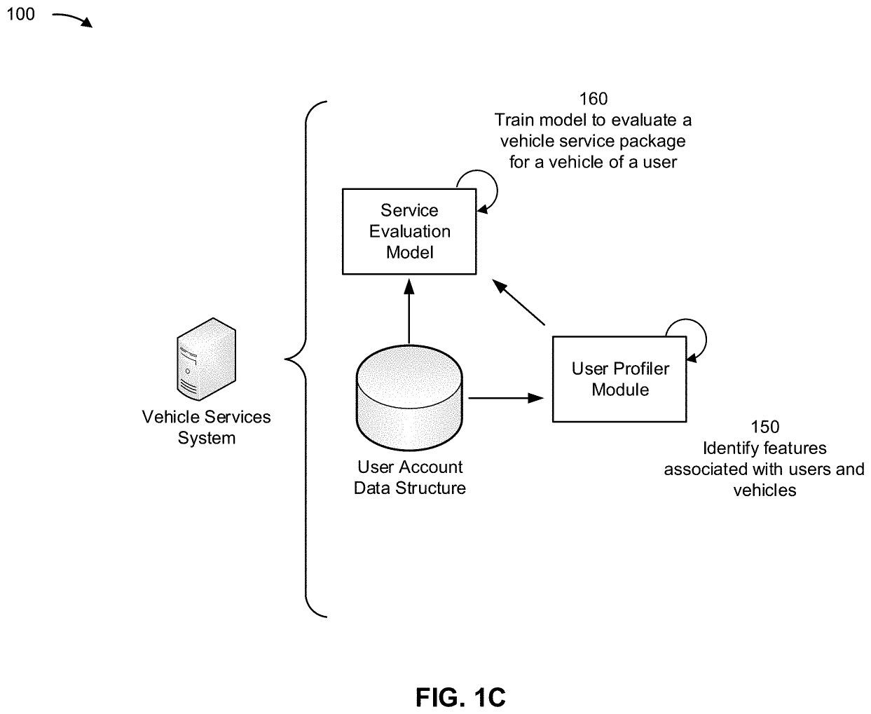

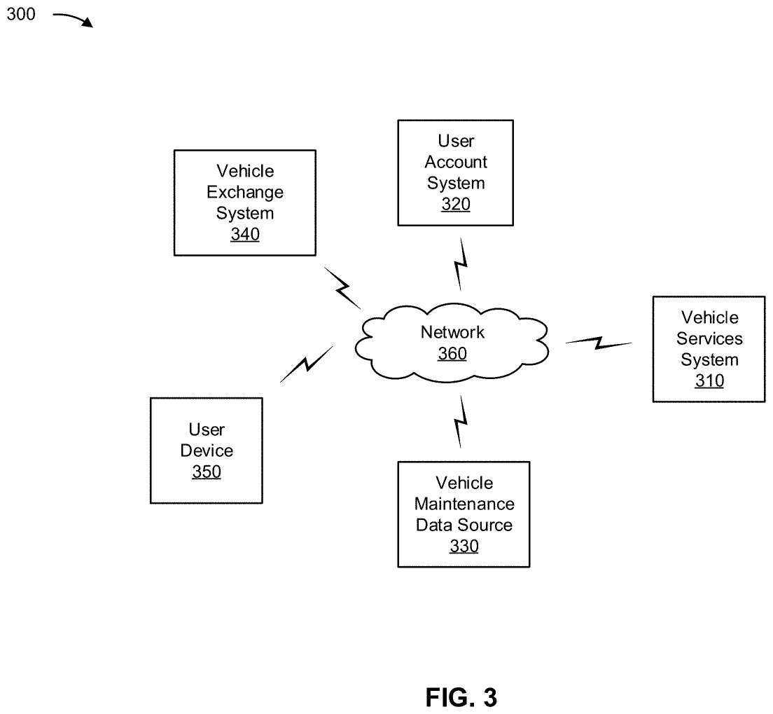

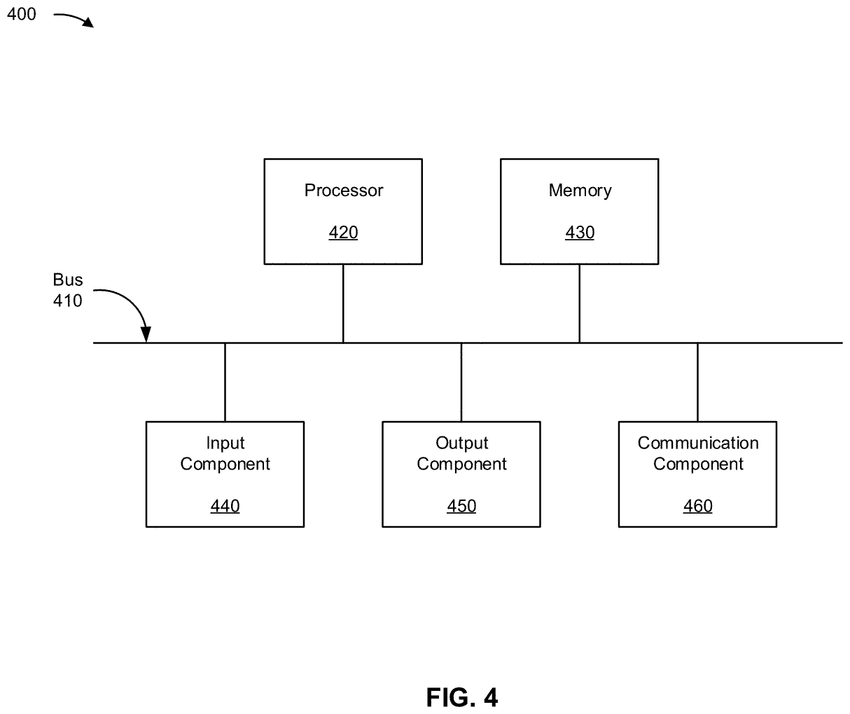

FIGS. 1A-1C are diagrams of an example implementation 100 relating to a system for evaluating a vehicle service for a vehicle based on information associated with a user of the vehicle. As shown in FIGS. 1A-1C, example implementation 100 includes a vehicle services system, a user account system, one or more vehicle exchange systems, a vehicle maintenance data source, and one or more user devices. These devices are described in more detail below in connection with FIG. 3 and FIG. 4.

As shown in FIG. 1A, and by reference number 110, the vehicle services system receives vehicle exchange information from users and/or dealerships. For example, the vehicle exchange information may include information associated with exchanges that previously occurred between users of user accounts associated with the user account system and dealerships that provide the vehicles in association with the exchanges. More specifically, for an exchange involving a user purchasing a vehicle, the exchange information may identify the user (e.g., via a user identifier of the user and/or an account identifier associated with a user account of the user) and the vehicle (e.g., via a vehicle identification number (VIN) associated with the vehicle). The exchange information may include other user information and/or vehicle information that is described elsewhere herein.

As further shown in FIG. 1A, and by reference number 120, the vehicle services system monitors information associated with users and vehicles. For example, the vehicle services system, based on receiving the exchange information, may monitor a user account associated with the user for records that involve a vehicle service associated with the vehicle. The vehicle service may include one or more services that are offered in service packages by the dealerships and/or that are offered and/or made available to users (e.g., prospective buyers or consumers) in association with the users engaging in exchanges for vehicles (e.g., purchases of the vehicles). For example, as shown, the vehicle services system may monitor a set of vehicle services that may be related to a vehicle warranty (e.g., a warranty associated with an engine, a powertrain, tires, brakes, or the like), rust protection (e.g., a service that involves coating portions of the vehicle with a seal to prevent rust), paint protection (e.g., a service that involves repairing or restoring a coat of paint to a vehicle), interior protection (e.g., a service that involves repairing or restoring damage to an interior of the vehicle, such as tears in upholstery or interior paneling). In this way, the users may opt to include one or more of the service packages within an exchange involving a vehicle to enable corresponding vehicle services to be applied to the vehicle, as described herein.

As an example, a user, when purchasing a vehicle, may purchase a rust protection plan to prevent a likelihood that the vehicle rusts within a certain time period (e.g., within ten years of the purchase). Accordingly, corresponding service packages may be configured to extend a useful life of the vehicle and/or reduce a user incurred cost associated with extending the useful life of the vehicle. For example, a cost of a service package that involves rust protection may, generally speaking, be less expensive than having to repair rust damage to the vehicle that would otherwise not have been covered if the user did not pay for the rust protection and/or did not have a vehicle service applied to the vehicle that includes rust protection. Furthermore, the vehicle service associated with rust protection may involve less time than a maintenance service to repair rust to the vehicle (e.g., because applying rust protection may involve applying a seal coating when the vehicle is relatively new, and repairing rusted components may involve more significant body work and/or replacement of components to the vehicle after the vehicle has aged).

In some implementations, the vehicle services system may monitor records that identify a merchant identifier associated with a type of merchant that provides a vehicle service (e.g., a dealership, an auto repair shop, and/or an autobody shop, among other examples). Additionally, or alternatively, the vehicle services system may monitor maintenance logs from the vehicle maintenance data source that indicate whether the vehicle was involved in a vehicle service (or multiple vehicle services). The maintenance logs may indicate occurrences of a vehicle and/or user receiving a vehicle service.

Accordingly, based on monitoring the information associated with the users and the vehicles, the vehicle services system may collect and/or store historical data associated with a vehicle service. The historical data stores, in association with the user accounts of users, information identifying types of vehicles associated with the users and whether the users opted into receiving the vehicle service in association with the previous exchanges for the vehicles.

In some implementations, from the maintenance logs, the vehicle services system may obtain vehicle usage information associated with the user and the vehicle. For example, a maintenance log may indicate mileage on a vehicle when a vehicle service is applied to the vehicle. Accordingly, based on a time when the vehicle was purchased, and a time associated with the vehicle service in the maintenance log, the vehicle services system can determine a vehicle usage rate (e.g., in terms of monthly miles driven or annual miles driven).

As shown in FIG. 1B, and by reference number 130, the vehicle services system receives and/or maintains information associated with the users, the vehicles, and one or more vehicle services. The vehicle services system may receive the information based on monitoring the user record logs and/or maintenance logs associated with the vehicle maintenance data structure. For example, the vehicle services system may receive vehicle service information from record logs of the users based on identifying that records (e.g., records that are associated with or identify a merchant that provides a vehicle service) are generated and/or stored. From such records, the vehicle services system may determine that the users incurred costs associated with the vehicle service and/or that a vehicle service was applied to vehicle of the users.

Additionally, or alternatively, the vehicle services system may receive vehicle maintenance information from the vehicle maintenance data structure (e.g., by querying the vehicle maintenance data structure using VINs of the vehicles) for vehicle maintenance information. The vehicle services system may determine that a vehicle was involved in a vehicle service from the maintenance logs including information that identifies a vehicle service and/or that is associated with a vehicle service.

In this way, the vehicle services system may receive and/or store, in the user account data structure, user information associated with a user, vehicle information associated with a vehicle, service package information associated with service packages purchased by the user, and/or vehicle maintenance information associated with the vehicle.

As further shown in FIG. 1B, and by reference number 140, the vehicle services system identifies features associated with vehicle maintenance and/or service performance. The features may indicate whether a vehicle received a service and/or whether a vehicle is associated with a particular service package. For example, the vehicle services system may identify the features from record logs of the users and/or from maintenance logs associated with the vehicles. The vehicle services system may indicate and/or store the features in user profiles associated with the users. A user profile may include vehicle information associated with vehicles of the user. As shown for a user (User 1), the vehicle information for a vehicle (Vehicle 1 Information) may include an identifier of the vehicle and/or that the user and the vehicle are associated with a rust service package and an interior service package, and maintenance information associated with the vehicle.

As a more specific example in FIG. 1B, the vehicle services system may identify and/or track, within the user profile, information associated with a rust service package. For example, from a maintenance log associated with the vehicle, the vehicle services system may identify that major body work was performed. Furthermore, the vehicle services system may identify that, on a same date (Jun. 24, 2019), a transaction in the transaction log involved a payment to a merchant identified with a merchant identifier that indicates that the merchant performed the body work. From the value of the transaction being relatively low for maintenance involving body work, the vehicle services system may determine (or infer) that the rust protection plan was utilized to incur a deductible and pay off a remainder of the major body work.

In this way, the vehicle services system may identify features associated with vehicle maintenance and/or a service performance of a vehicle service.

As shown in FIG. 1C, and by reference number 150, the vehicle services system identifies features associated with users of the user accounts. The vehicle services system may identify the features from the vehicle information, and/or from user information associated with the user. The vehicle services system may store and/or maintain the features in association with the user profiles of the users. For example, for a user profile, the vehicle services system may identify or indicate the user information associated with the user (e.g., a name, an account identifier (Account #), a vehicle usage rating, or the like).

The features may indicate or be associated with certain user characteristics of the users being associated with certain vehicles (or types of vehicles), whether users with certain user characteristics and/or types of vehicles opted into receiving a particular vehicle service (e.g., and/or opted into including a corresponding service package in a purchase of a vehicle), whether users that opted into receiving a particular vehicle service share a common characteristic (e.g., are from a same location, from a same geo-based region, have a same vehicle usage rate, use the vehicle for a same purpose, or the like). In this way, the features may be associated with certain trends or patterns that are based on or associated with sets of characteristics of the users, characteristics of the vehicles, whether the vehicles received services associated with service packages during a particular time period, whether certain users from certain locations or regions opted into receiving a vehicle service, and so on.

In this way, the vehicle services system may identify features associated with users, vehicles, and vehicle services, to enable the vehicle services system to train the service evaluation model to evaluate a vehicle service for a user (e.g., based on applications of the vehicle service and/or usage of service packages in association with vehicles being involved in a vehicle service).

As further shown in FIG. 1C, and by reference number 160, the vehicle services system trains the service evaluation model to evaluate a vehicle service package in association with a user and a vehicle. For example, the service evaluation model may be trained based on the historical data associated with similarities between characteristics of the user and/or the vehicle as indicated in the user profiles of the user accounts. Accordingly, the service evaluation model may be trained according to whether the users opted into receiving the vehicle service in association with previous exchanges for vehicles.

In some implementations, the service evaluation model may include or may be associated with a machine learning model that is configured to evaluate a vehicle service according to the historical data associated with the user accounts. For example, the vehicle services system (or another system associated with the vehicle services system) may train the service evaluation model based on one or more performance parameters associated with a vehicle service (or a service package), such as a cost of a service package associated with the vehicle service, costs incurred by users that opted into receiving the vehicle service via a service package, costs incurred by users that opted out of receiving the vehicle service via the service package, whether a vehicle service was required after purchase or opting into a vehicle service package, a quantity of user accounts of users that opted into a service package associated with the vehicle service (and/or that opted out of a service package), user characteristics of users (e.g., a location associated with the user, a vehicle usage rate associated with the user, a vehicle usage type associated with the user, or the like) that opted into receiving the vehicle service or purchasing a service package, and/vehicle characteristics (e.g., type of vehicle, make/model of vehicle, year of manufacture of vehicle, or the like), among other examples. The vehicle services system may train the service evaluation model using the historical data associated with evaluating a vehicle service for a user and a vehicle according to the one or more the vehicle service performance parameters. Using the historical data and the one or more vehicle service performance parameters as inputs to the service evaluation model, the vehicle services system may evaluate a service in association with a user and a vehicle (e.g., a user engaging in an exchange involving the vehicle) to determine and/or indicate whether the user should opt into receiving the vehicle service and/or including a service package for the vehicle service in an exchange involving the vehicle.

The service evaluation model may provide and/or output an evaluation score for a vehicle service that is indicative of whether the vehicle service would be beneficial or useful for a user and a vehicle. For example, the service evaluation model may identify a characteristic of the user and/or a type of the vehicle and, based on being trained (e.g., using any suitable machine learning technique) according to the historical data of the user accounts, determine the evaluation score, and/or indicate a recommendation according to the evaluation score.

In this way, using historical data associated with users, vehicles of the users, and whether the users received a vehicle service in association with the vehicle, the vehicle services system may train the service evaluation model to evaluate a vehicle service, as described elsewhere herein. Additionally, or alternatively, the service evaluation model may iteratively analyze and/or evaluate multiple vehicle services to indicate a ranking of vehicle services that may be most relevant to a user and/or a vehicle, as described herein.

As indicated above, FIGS. 1A-1C are provided as an example. Other examples may differ from what is described with regard to FIGS. 1A-1C. The number and arrangement of devices shown in FIGS. 1A-1C are provided as an example. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) shown in FIGS. 1A-1C may perform one or more functions described as being performed by another set of devices shown in FIGS. 1A-1C.

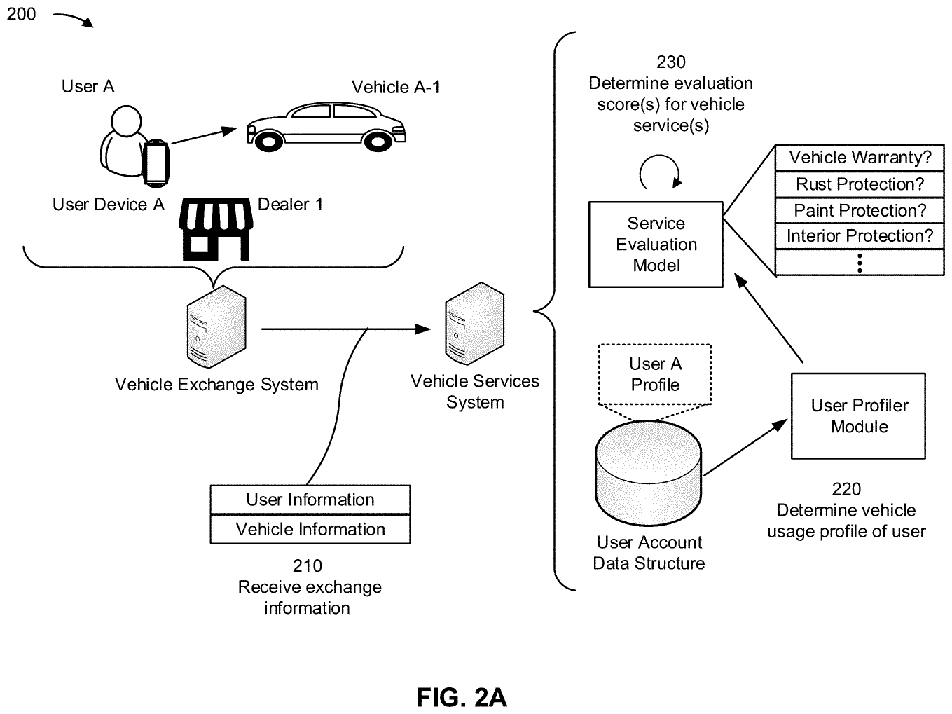

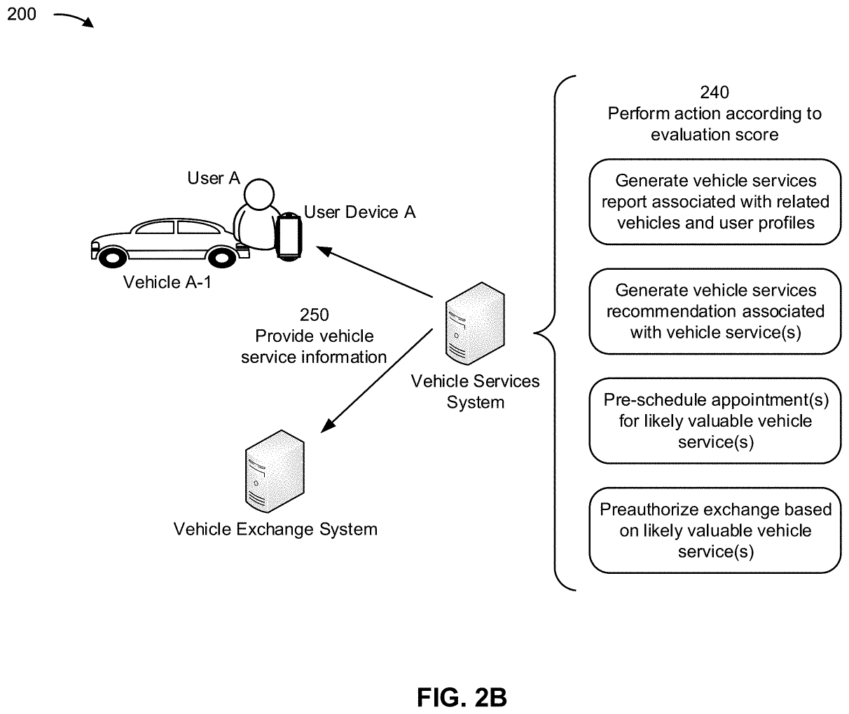

FIGS. 2A-2B are diagrams of an example implementation 200 associated with evaluating a vehicle service for a vehicle based on information associated with a user of the vehicle. As shown in FIGS. 2A-2B, example implementation 200 includes a vehicle services system, a vehicle exchange system, and a user device. These devices are described in more detail below in connection with FIG. 3 and FIG. 4.

In example implementation 200, the vehicle exchange system may facilitate an exchange involving a user (User A) and a vehicle (Vehicle A-1). As shown, the vehicle exchange system may be associated with a dealership (Dealer 1). The user may be associated with a user device (User Device A). The user device may include an application that is associated with the vehicle services system. For example, the vehicle services system may be associated with a backend system of the application and the user device may include a user-side version of the application that enables the user to interact with the vehicle services system.

As shown in FIG. 2A, and by reference number 210, the vehicle services system receives exchange information associated with the user and the vehicle. The vehicle services system may receive the exchange information within a notification from the user device and/or a notification from the vehicle exchange system (e.g., based on the user engaging in the exchange). The notification and/or the exchange information may indicate that the user is engaging in an exchange that involves the vehicle (e.g., that the user is at the dealership and/or seeking to purchase the vehicle).

As shown, the exchange information may include user information and vehicle information. The user information may include an identifier of the user (e.g., a name of the user and/or an account identifier associated with a user account of the user) and/or a location associated with the user (e.g., an address of the user and/or a location of the user) and/or a location associated with usage of the vehicle by the user (e.g., a location of a jurisdictional registration of the vehicle).

In some implementations, the vehicle services system may obtain certain user information based on receiving the exchange information. In some implementations, the vehicle services system may obtain the information from a user profile associated with the user (e.g., a user profile similar to the user profiles in example implementation 100). Accordingly, from the user profile, the vehicle services system may obtain user information that includes one or more vehicle-specific characteristics associated with the user. For example, the user information may indicate a vehicle usage rate (e.g., a monthly or annual quantity of miles driven by a user) and/or a vehicle usage type, such as a purpose of the user using the vehicle or purchasing the vehicle (e.g., routine/day-to-day use, business, recreation, collection, or the like), and/or whether the user has family or children (which may be indicative of type of usage).

The vehicle information may include a vehicle identifier (e.g., a VIN), a make/model of the vehicle, a year of manufacture of the vehicle, a type of the vehicle, a color of the vehicle, attributes or accessories of the vehicle, a trim level of the vehicle, among other types of information associated with the vehicle.

As further shown in FIG. 2A, and by reference number 220, the vehicle services system determines a vehicle usage profile of the user. The vehicle usage profile (and/or one or more characteristics of the user in the user profile) may be determined based on the user information identifying the user profile associated with the user. The vehicle usage profile may indicate a characteristic of the user, such as a vehicle usage rate of the user (e.g., how often a user drives or uses a vehicle), a vehicle usage type of the user (e.g., a purpose of the user driving or using a vehicle), or a location associated with usage of the vehicle (e.g., an address of the user and/or a registration location of the vehicle).

In some implementations, the vehicle services system may look up vehicle usage information associated with the user. For example, the vehicle services system may identify a characteristic of the user in a user profile (e.g., User A Profile) associated with a user account of the user, which may be managed by the user account data structure. The characteristic and/or the vehicle usage information may be provided by the user and/or determined based on mileage or location information indicated in maintenance records associated with one or more vehicles of the user (e.g., one or more other vehicles owned or previously owned by the user).

As further shown in FIG. 2A, and by reference number 230, the vehicle services system determines an evaluation score for a vehicle service. For example, the vehicle services system may evaluate a vehicle service relative to the user and the vehicle. The vehicle services system may determine multiple evaluation scores for multiple corresponding vehicle services (e.g., as shown, evaluate whether the user should get a vehicle warranty, whether the user should get rust protection, whether the user should get paint protection, whether the user should get interior protection, among other examples).

In some implementations, the vehicle services system (e.g., via the service evaluation model) may analyze, in an account data structure (e.g., the user account data structure), vehicle service information (e.g., in historical data of the user account data structure) associated with user accounts that are related to a characteristic of the user. The vehicle service information may be indicative of whether users associated with the user accounts (or subsets of user accounts of users that are associated with the user based on having a common user characteristic, such as a same location and/or vehicle usage characteristic) received the vehicle service in association with previous exchanges involving respective vehicles of the users. In some implementations, the user accounts are analyzed (and/or selected for analysis) based on the user accounts being a subset of user accounts that are associated with vehicles (e.g., associated with users that own or owned the vehicles) that are a same type of vehicle as the vehicle.

The vehicle services system may identify user accounts in the user account data structure that are associated with certain users. For example, the user accounts may be identified based on the type of the vehicle being indicated in the vehicle information, based on a characteristic of the user being associated with user profiles of the user accounts, and/or based on the location being within a threshold distance of locations associated with users of the user accounts, among other examples. In this way, rather than evaluating the vehicle service based on all user accounts that are maintained via the user account data structure, the vehicle services system may evaluate the vehicle service based on a subset of user accounts that are associated with certain types of users, certain types of vehicles, and/or whether users of the accounts opted into or opted out of receiving a particular vehicle service.

In some implementations, the vehicle services system may analyze records of user accounts to evaluate a vehicle service (e.g., determine whether a vehicle service is worth including in an exchange for a vehicle). The vehicle services system may compare a subset (e.g., a first subset) of user accounts of users that opted into receiving a vehicle service with a subset (e.g., a second subset) of user accounts that did not opt into receiving the vehicle service. The subsets of the user accounts may be associated with users that have a common user characteristic and/or users that own or owned a same type of vehicle. For example, the vehicle services system may compare first records (e.g., transaction records and/or maintenance records) from user accounts of users that opted into receiving the service with second records from user accounts of users that opted out of receiving the service. Based on a comparison of the records, the vehicle services system may identify a difference in costs identified from the records (e.g., average costs of the vehicle service per user account) and costs of a service package associated with the vehicle service. More specifically, vehicle services system may determine the evaluation score based on a first average of record values (e.g., vehicle service cost values) associated with individual user accounts of the first records and a value of a service package (e.g., from historical exchange information or a catalog of service packages) associated with the vehicle service (e.g., because the users opted into paying for the service package), and a second average of record values associated with individual user accounts of the second subset. For example, if the costs of the service package and average costs of the vehicle maintenance involving the vehicle service for users that opted into receiving the vehicle service are less than the average costs of the vehicle maintenance to the users that opted out of receiving the vehicle service, the evaluation score may indicate (e.g., based on satisfying a threshold) that the user should opt into receiving the vehicle service. On the other hand, if the costs of the service package and average costs of the vehicle maintenance involving the vehicle service for users that opted into receiving the vehicle service are greater than the average costs of the vehicle maintenance to the users that opted out of receiving the vehicle service, the evaluation score may indicate (e.g., based on not satisfying a threshold) that the user should opt-out of receiving the vehicle service.

In this way, the vehicle services system may determine, based on the vehicle service information and user accounts of users associated with the user and/or user accounts with vehicle information associated with the vehicle, an evaluation score that is associated with the user receiving the vehicle service, opting into receiving the vehicle service, and/or including a service package in an exchange for the vehicle.

As shown in FIG. 2B, and by reference number 240, the vehicle services system performs one or more actions according to the evaluation scores. For example, based on the evaluation score satisfying a threshold, the vehicle services system may perform an action associated with a service package involving the vehicle service and the user. The threshold may be indicative of the vehicle service being provided to a threshold percentage of users that have a same characteristic of the user and/or are associated with a same type of vehicle as the vehicle.

In some implementations, the vehicle services system may generate a vehicle services report that indicates a utilization of the vehicle service in association with the vehicle type and a characteristic of the user. For example, the utilization may indicate a frequency or rate of users that are associated with the user (e.g., users that have a same characteristic as the user) opting into receiving the vehicle service and/or including a service package involving the vehicle service in an exchange for a same type of vehicle as the vehicle. In some implementations, the report may include a ranking of vehicle services based on evaluation scores of the vehicle services. For example, the ranking may indicate which vehicle services are likely to be the most useful, most beneficial, and/or most cost effective for the user.

Additionally, or alternatively, the vehicle services system may generate a vehicle services recommendation that indicates whether the user should opt into the vehicle service. In some implementations, the recommendation indicates a ranking of the vehicle service relative to other vehicle services that are available to the user. The ranking may be based on evaluation scores associated with the other vehicle services that are determined by the service evaluation model, as described elsewhere herein.

In some implementations, the vehicle services system may schedule (or preschedule) an appointment for the user to receive the vehicle service. For example, if the vehicle services system determines that the user should opt into receiving rust protection, the vehicle services system may preschedule an appointment (e.g., designate a time slot for the appointment if the time slot is accepted by the user) for the vehicle to be treated with a rust protection coating and/or pre-order materials for the rust protection coating, to permit the user to quickly receive the vehicle service (e.g., if the user includes a service package for rust protection in the exchange for the vehicle).

In some implementations, the vehicle services system may preauthorize the exchange for the vehicle based on a cost of the service package. For example, based on a determination that the user should include a service package involving the vehicle service in the exchange, the vehicle services system may add a cost of the service package to a cost of the vehicle to determine an updated cost of the exchange (e.g., an updated purchase price based on the service package being added to the exchange) and preauthorize the user for a loan in an amount of the updated cost. Additionally, or alternatively, the vehicle services system may generate an offer that includes information associated with adding the service package to the exchange (e.g., an offer that includes the updated costs and/or the recommendation of including the service package in the exchange).

As further shown in FIG. 2B, and by reference number 250, the vehicle services system provides vehicle service information to the user and/or the vehicle exchange system of the dealership. For example, the vehicle services system may provide the recommendation to the user (e.g., to the user device and/or the vehicle exchange system of the dealership) to permit the user to opt into receiving the vehicle service (e.g., based on including the service package in the exchange). Additionally, or alternatively, the vehicle services system may provide a report of the available vehicle services that were generated based on evaluation scores of the vehicle services to permit the user to determine which vehicle services may be most beneficial and/or cost effective to the user according to previous exchanges involving other users and/or other vehicles (e.g., rather than requiring the user to sift through all available vehicle services and/or make a determination of which vehicle services are most beneficial and/or cost effective).

As indicated above, FIGS. 2A-2B are provided as an example. Other examples may differ from what is described with regard to FIGS. 2A-2B. The number and arrangement of devices shown in FIGS. 2A-2B are provided as an example. In practice, there may be additional devices, fewer devices, different devices, or differently arranged devices than those shown in FIGS. 2A-2B. Furthermore, two or more devices shown in FIGS. 2A-2B may be implemented within a single device, or a single device shown in FIGS. 2A-2B may be implemented as multiple, distributed devices. Additionally, or alternatively, a set of devices (e.g., one or more devices) shown in FIGS. 2A-2B may perform one or more functions described as being performed by another set of devices shown in FIGS. 2A-2B.

FIG. 3 is a diagram of an example environment 300 in which systems and/or methods described herein may be implemented. As shown in FIG. 3, environment 300 may include a vehicle services system 310, a user account system 320, a vehicle maintenance data source 330, a vehicle exchange system 340, a user device 350, and a network 360. Devices of environment 300 may interconnect via wired connections, wireless connections, or a combination of wired and wireless connections.

The vehicle services system 310 includes one or more devices capable of receiving, generating, storing, processing, providing, and/or routing information associated with an evaluation of a vehicle service for a vehicle based on user information associated with a user of the vehicle and/or vehicle information associated with the vehicle, as described elsewhere herein. The vehicle services system 310 may include a communication device and/or a computing device. For example, the vehicle services system 310 may include a server, such as an application server, a client server, a web server, a database server, a host server, a proxy server, a virtual server (e.g., executing on computing hardware), or a server in a cloud computing system. In some implementations, the vehicle services system 310 includes computing hardware used in a cloud computing environment.

The user account system 320 includes one or more devices capable of receiving, generating, storing, processing, providing, and/or routing information associated with user accounts of users and/or vehicles associated with the users, as described elsewhere herein. The user account system 320 may include a communication device and/or a computing device. For example, the user account system 320 may include a server, such as an application server, a client server, a web server, a database server, a host server, a proxy server, a virtual server (e.g., executing on computing hardware), or a server in a cloud computing system. In some implementations, the user account system 320 includes computing hardware used in a cloud computing environment.

The vehicle maintenance data source 330 includes one or more devices capable of receiving, generating, storing, processing, and/or providing information associated with maintenance performed on vehicles, as described elsewhere herein. The vehicle maintenance data source 330 may include a communication device and/or a computing device. For example, the vehicle maintenance data source 330 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The vehicle maintenance data source 330 may be associated with an entity that is configured to collect, provide, and/or report vehicle maintenance information associated with certain vehicle services performed on a vehicle. The entity may receive the vehicle maintenance information from vehicle service providers (e.g., dealerships, auto repair shops, autobody shops, or the like). The vehicle maintenance data source 330 may communicate with one or more other devices of environment 300, as described elsewhere herein.

The vehicle exchange system 340 includes one or more devices capable of processing, authorizing, and/or facilitating an exchange (e.g., a transaction) involving a vehicle. For example, the vehicle exchange system 340 may include one or more servers and/or computing hardware (e.g., in a cloud computing environment or separate from a cloud computing environment) configured to receive and/or store information associated with processing an electronic transaction. The vehicle exchange system 340 may process the exchange to approve (e.g., permit, authorize, or the like) or decline (e.g., reject, deny, or the like) the exchange and/or to complete the transaction if the transaction is approved. The vehicle exchange system 340 may process the electronic transaction based on information received from a transaction terminal, such as transaction data (e.g., information that identifies a transaction amount, a merchant, a time of a transaction, a location of the transaction, or the like), account information communicated to the transaction terminal by a transaction device (e.g., a transaction card, a mobile device executing a payment application, or the like) and/or information stored by the vehicle exchange system 340 (e.g., for fraud detection).

The user device 350 includes one or more devices capable of receiving, generating, storing, processing, and/or providing, in association with a user of the user device 350, information associated with one or more vehicle services, recommendations for vehicle services, and/or one or more reports associated with vehicle services, as described elsewhere herein. The user device 350 may include a communication device and/or a computing device. For example, the user device 350 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The network 360 includes one or more wired and/or wireless networks. For example, the network 360 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 360 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400, which may correspond to the vehicle services system 310, the user account system 320, the vehicle maintenance data source 330, the vehicle exchange system 340, and/or the user device 350. In some implementations, the vehicle services system 310, the user account system 320, the vehicle maintenance data source 330, the vehicle exchange system 340, and/or the user device 350 may include one or more devices 400 and/or one or more components of device 400. As shown in FIG. 4, device 400 may include a bus 410, a processor 420, a memory 430, an input component 440, an output component 450, and a communication component 460.

Bus 410 includes one or more components that enable wired and/or wireless communication among the components of device 400. Bus 410 may couple together two or more components of FIG. 4, such as via operative coupling, communicative coupling, electronic coupling, and/or electric coupling. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform one or more operations or processes described elsewhere herein.

Memory 430 includes volatile and/or nonvolatile memory. For example, memory 430 may include random access memory (RAM), read only memory (ROM), a hard disk drive, and/or another type of memory (e.g., a flash memory, a magnetic memory, and/or an optical memory). Memory 430 may include internal memory (e.g., RAM, ROM, or a hard disk drive) and/or removable memory (e.g., removable via a universal serial bus connection). Memory 430 may be a non-transitory computer-readable medium. Memory 430 stores information, instructions, and/or software (e.g., one or more software applications) related to the operation of device 400. In some implementations, memory 430 includes one or more memories that are coupled to one or more processors (e.g., processor 420), such as via bus 410.

Input component 440 enables device 400 to receive input, such as user input and/or sensed input. For example, input component 440 may include a touch screen, a keyboard, a keypad, a mouse, a button, a microphone, a switch, a sensor, a global positioning system sensor, an accelerometer, a gyroscope, and/or an actuator. Output component 450 enables device 400 to provide output, such as via a display, a speaker, and/or a light-emitting diode. Communication component 460 enables device 400 to communicate with other devices via a wired connection and/or a wireless connection. For example, communication component 460 may include a receiver, a transmitter, a transceiver, a modem, a network interface card, and/or an antenna.

Device 400 may perform one or more operations or processes described herein. For example, a non-transitory computer-readable medium (e.g., memory 430) may store a set of instructions (e.g., one or more instructions or code) for execution by processor 420. Processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, processor 420 may be configured to perform one or more operations or processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

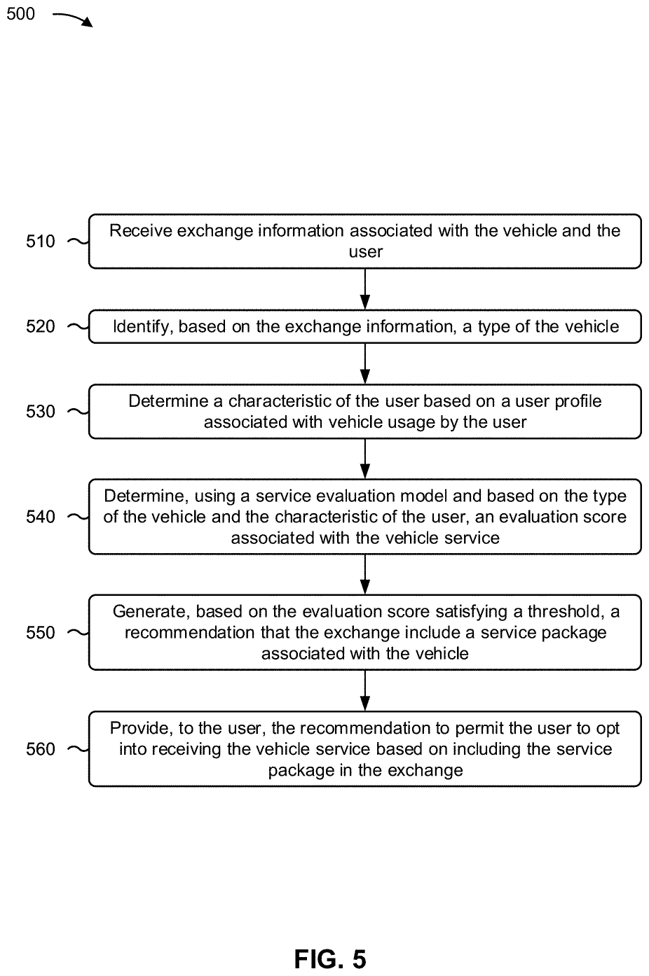

FIG. 5 is a flowchart of an example process 500 associated with evaluating a vehicle service for a vehicle based on information associated with a user of the vehicle. In some implementations, one or more process blocks of FIG. 5 may be performed by a vehicle services system (e.g., vehicle services system 310). In some implementations, one or more process blocks of FIG. 5 may be performed by another device or a group of devices separate from or including the vehicle services system, such as the user account system 320, the vehicle exchange system 340, and/or the user device 350. Additionally, or alternatively, one or more process blocks of FIG. 5 may be performed by one or more components of device 400, such as processor 420, memory 430, input component 440, output component 450, and/or communication component 460.

As shown in FIG. 5, process 500 may include receiving exchange information associated with the vehicle and the user (block 510). The exchange information may indicate that the user is engaging in an exchange that involves the vehicle. As further shown in FIG. 5, process 500 may include identifying, based on the exchange information, a type of the vehicle (block 520).

As further shown in FIG. 5, process 500 may include determining a characteristic of the user based on a user profile associated with vehicle usage by the user (block 530). As further shown in FIG. 5, process 500 may include determining, using a service evaluation model and based on the type of the vehicle and the characteristic of the user, an evaluation score associated with the vehicle service (block 540). The service evaluation model may be trained based on historical data associated with user accounts of users opting into receiving the vehicle service in association with previous exchanges for vehicles.

As further shown in FIG. 5, process 500 may include generating, based on the evaluation score satisfying a threshold, a recommendation that the exchange include a service package associated with the vehicle (block 550). As further shown in FIG. 5, process 500 may include providing, to the user, the recommendation, to permit the user to opt into receiving the vehicle service based on including the service package in the exchange (block 560).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for evaluating a vehicle service for a vehicle and a user, the system comprising:
one or more memories; and
one or more processors, communicatively coupled to the one or more memories, configured to:
receive exchange information associated with the vehicle and the user,
wherein the exchange information indicates that the user is engaging in an exchange that involves the vehicle;
identify, based on the exchange information, a type of the vehicle;
determine a characteristic of the user based on a user profile associated with vehicle usage by the user;
determine, using a service evaluation model and based on the type of the vehicle and the characteristic of the user, an evaluation score associated with the vehicle service, wherein the service evaluation model is trained based on historical data
associated with user accounts of users opting into receiving the vehicle service in association with previous exchanges for vehicles;
generate, based on the evaluation score satisfying a threshold, a recommendation that the exchange include a service package associated with the vehicle; and
provide, to the user, the recommendation to permit the user to opt into receiving the vehicle service based on including the service package in the exchange.

2. The system of claim 1, wherein the historical data stores, in association with the user accounts of users, information identifying types of vehicles associated with the users and whether the users opted into receiving the vehicle service in association with the previous exchanges for the vehicles.

3. The system of claim 1, wherein the exchange information includes vehicle information associated with the vehicle,
wherein the type of the vehicle is identified based on the vehicle information.

4. The system of claim 1, wherein the exchange information includes user information associated with the user,
wherein the characteristic of the user is determined based on the user information identifying the user profile associated with the user.

5. The system of claim 1, wherein the characteristic of the user is indicative of at least one of:
a vehicle usage rate of the user,
a vehicle usage type of the user, or
a location associated with usage of the vehicle by the user.

6. The system of claim 1, wherein the service evaluation model, to determine the evaluation score, is configured to:
identify, based on a type of the vehicle and within the historical data, a subset of the user accounts that are associated with the type of the vehicle and associated with the characteristic of the user; and
determine the evaluation score based on a quantity of the subset of the user accounts.

7. The system of claim 1, wherein the recommendation indicates a ranking of the vehicle service relative to other vehicle services that are available to the user,
wherein the ranking is based on evaluation scores associated with the other vehicle services that are determined by the service evaluation model.

8. A non-transitory computer-readable medium storing a set of instructions, the set of instructions comprising:
one or more instructions that, when executed by one or more processors of a system, cause the system to:
receive exchange information associated with a vehicle and a user,
wherein the exchange information indicates that the user is engaging in an exchange that involves the vehicle;
obtain, based on receiving the exchange information, user information associated with the user;
analyze, in an account data structure, vehicle service information associated with user accounts that are related to a characteristic of the user;
determine, based on the vehicle service information and a subset of the user accounts that include user profiles that identify the characteristic, an evaluation score that is associated with the user receiving the vehicle service; and
perform, based on the evaluation score satisfying a threshold, an action associated with a service package involving the vehicle service and the user,
wherein the threshold is indicative of the vehicle service being provided to a threshold percentage of users associated with the subset of the user accounts.

9. The non-transitory computer-readable medium of claim 8, wherein the vehicle service information is indicative of whether users associated with the subset of the user accounts received the vehicle service in association with previous exchanges involving respective vehicles of the users.

10. The non-transitory computer-readable medium of claim 8, wherein the user accounts are analyzed based on the user accounts being associated with vehicles that are a same type of vehicle as the vehicle.

11. The non-transitory computer-readable medium of claim 8, wherein the user information includes a user identifier that is associated with a user account of the user,
wherein the characteristic of the user is identified in a user profile associated with the user account.

12. The non-transitory computer-readable medium of claim 8, wherein the exchange information includes location information that identifies a location associated with the user,
wherein the user accounts are identified based on the location being within a threshold distance of locations associated with users of the user accounts.

13. The non-transitory computer-readable medium of claim 8, the characteristic of the user is indicative of at least one of:
a vehicle usage rate of the user,
a vehicle usage type of the user, or
a location associated with usage of the vehicle by the user.

14. The non-transitory computer-readable medium of claim 8, wherein the one or more instructions, that cause the system to perform the action, cause the system to:
generate a vehicle services report that indicates a utilization of the vehicle service in association with a type of the vehicle and a characteristic of the user,
generate a vehicle services recommendation that indicates whether the user should opt into the vehicle service,
schedule an appointment associated with the user receiving the vehicle service in association with the vehicle, or
preauthorize the exchange based on a service package involving the vehicle service being added to the exchange.

15. A method for evaluating a vehicle service for a vehicle and a user, comprising:
receiving, by a device, exchange information associated with the vehicle and the user,
wherein the exchange information indicates that the user is engaging in an exchange that involves the vehicle;
identifying, by the device and based on a type of the vehicle and within an account data structure, user accounts that are associated with the type of the vehicle;
identifying, by the device and from a first subset of the user accounts, first records that are associated with vehicle maintenance,
wherein first user accounts of the first subset are associated with first users that opted into receiving the vehicle service;
identifying, by the device and from a second subset of the user accounts, second records that are associated with vehicle maintenance,
wherein second user accounts of the second subset are associated with second users that opted out of receiving the vehicle service;
determining, by the device and based on a comparison of the first records and the second records, an evaluation score associated with the vehicle service and the type of the vehicle; and
performing, by the device and based on the evaluation score, an action associated with the vehicle service and the user.

16. The method of claim 15, comprising wherein the exchange information comprises vehicle information associated with the vehicle,
wherein the user accounts are identified based on the type of the vehicle being indicated in the vehicle information.

17. The method of claim 15, wherein the exchange information includes user information associated with the user,
wherein the user accounts are identified based on a characteristic of the user being associated with user profiles of the user accounts.

18. The method of claim 15, wherein the exchange information includes location information that identifies a location associated with the user,
wherein the user accounts are identified based on the location being within a threshold distance of locations associated with users of the user accounts.

19. The method of claim 15, wherein the evaluation score is determined based on a degree of difference between:
a first average of record values associated with individual user accounts of the first subset and a value of a service package associated with the vehicle service, and
a second average of record values associated with individual user accounts of the second subset.

20. The method of claim 15, wherein performing the action comprises:
generating a vehicle services report that indicates a utilization of the vehicle service in association with a type of the vehicle type and a characteristic of the user,
generating a vehicle services recommendation that indicates whether the user should opt into the vehicle service,
scheduling an appointment associated with the user receiving the vehicle service in association with the vehicle, or
preauthorizing the exchange based on a service package involving the vehicle service being added to the exchange.
